(19) United States
(12) Patent Application Publication
(10) Pub. No.: US 2002/0133896 A1
(43) Pub. Date: Sep. 26, 2002

(54) Windscreen wiper joint for automobiles

(76) Inventors: Dirk Herinckx, Drieslinter (BE); Jurgen Roekens, Steenokkerseel (BE)

Correspondence Address: Michael J Striker, Striker Striker & Stenby, 103 East Neck Road, Huntington, NY, 11743, US

(21) Appl. No.: 10/049,494

(22) PCT Filed: Jun. 7, 2001
(86) PCT No.: PCT/DE01/02140

(30) Foreign Application Priority Data
Jun. 16, 2000 (DE) 10029713.7

(51) Int. Cl. B60S 1/38

(52) U.S. Cl. 15/250.46; 15/250.44

(57) ABSTRACT

A windshield wiper for motor vehicles, having a support bracket (1) for connection to a wiper arm secured to a motor vehicle, wherein the support bracket (1) has an essentially U-shaped cross section and at least one support bracket detent recess (10); at least one lower bracket (2) for connection to a rubber wiper blade, and the lower bracket (2) has an essentially U-shaped cross section and at least one lower bracket detent recess (15) and is at least partly embraced by the support bracket (1); and a joint (3) for pivotably connecting the at least one lower bracket (2) to the support bracket (1), and the joint (3) has at least one lower bracket detent body (24), for locking onto the at least one lower bracket detent recess (15), and at least one support bracket detent body (22) for locking onto the at least one support bracket detent recess (10), which support bracket detent body (22) is provided in a pocket (20).

The invention relates to a windshield wiper for motor vehicles.

In the prior art, numerous possibilities are known, in a windshield wiper, for pivotably connecting a support bracket, connected to the wiper arm, to a lower bracket that carries the rubber wiper blade. Most of these joints for connecting the lower bracket and the support bracket are complicated in structure and are unsuited to automated assembly.

The object of the invention is to refine a windshield wiper of the type defined above in such a way that a pivotable connection between the support bracket and the lower bracket that can be assembled as simply as possible and is durable is created.

This object is attained by the characteristics of claim 1. The nucleus of the invention is, in a joint of essentially U-shaped cross section, to provide pockets on the outsides, in which a support bracket detent body for locking onto the support bracket is provided.

The advantage of the embodiment according to claim 2 is that the most compact possible connection is created between the joint and the lower bracket.

The advantage of the embodiment according to claim 3 is that the simplest possible assembly is assured by the insertion from the free end of the support bracket.

The advantage of the embodiment according to claim 4 is that the free end of the support bracket is partly concealed by the pocket, creating an aesthetically appealing closure.

Providing two lower bracket detent bodies in accordance with claim 5 creates pivotability about a pivot axis extending through the two lower bracket detent bodies.

Providing a spring slit in accordance with claim 6 makes it easier to press the lower bracket detent bodies together and makes them lock better onto the lower bracket.

The wedge-shaped design of the support bracket detent body makes it easier to slip the support bracket detent body on and lock it onto the support bracket detent recess.

By the rectangular embodiment of the support bracket detent recess in accordance with claim 9, the joint is fixed relative to the support bracket with as much freedom from pivoting as possible. Embodying the support bracket detent recess as a keyhole open to the outside enables the simplest possible slipping and locking of the support bracket onto the joint.

Additional characteristics and details of the invention will become apparent from the description of two exemplary embodiments in conjunction with the drawing. Shown are:

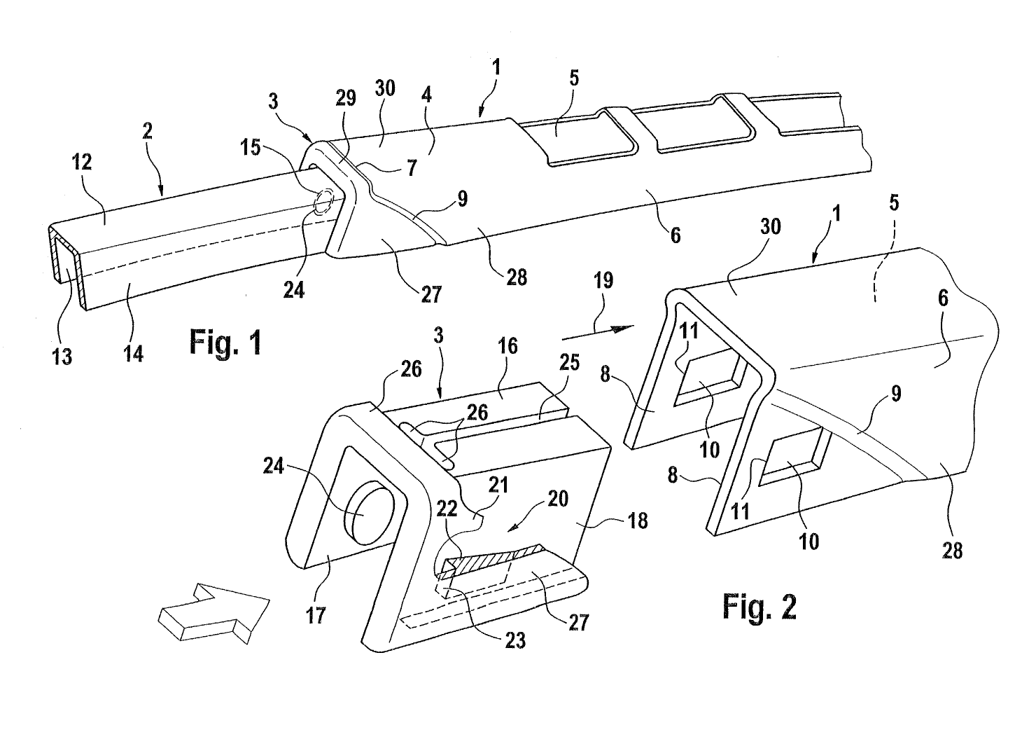

FIG. 1, a plan view on a mounted unit comprising a support bracket, connected to a lower bracket via a joint, in a first embodiment;

FIG. 2, an exploded view of the support bracket and joint of FIG. 1;

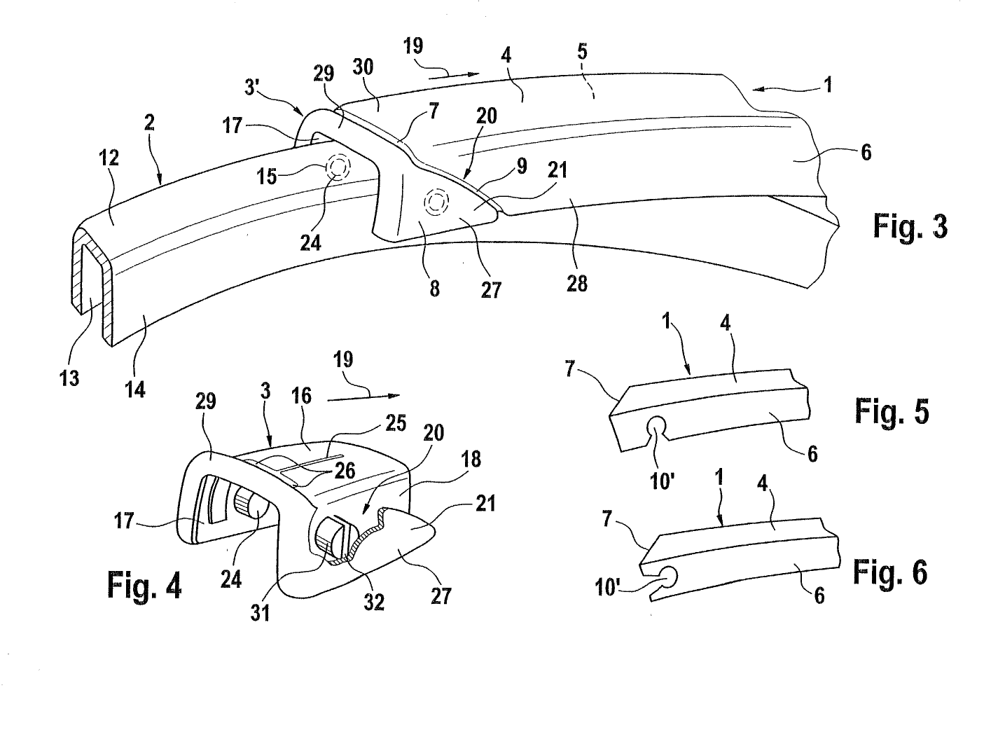

FIG. 3, a plan view on a mounted unit comprising a support bracket, connected to a lower bracket via a joint, in a second embodiment;

FIG. 4, a plan view of the joint of FIG. 3;

FIG. 5, a plan view of the support bracket of FIG. 3; and

FIG. 6, a plan view of a support bracket modified over FIG. 3.

A first embodiment of the invention will be described below in conjunction with FIGS. 1 and 2. A windshield wiper for a motor vehicle is pivotably connected to the free end of a wiper arm, which in turn is connected to a motor vehicle. The windshield wiper has a central support bracket 1, connected to the wiper arm; this support bracket is also known as a middle bracket. In the region of the two free ends of the support bracket 1, a respective lower bracket 2, also known as a claw bracket, is pivotably connected via a joint 3. A rubber wiper blade or another lower bracket 2 is secured to the free ends of the two lower brackets 2.

The support bracket 1, which is of metal, has a U-shaped cross section open toward the bottom and is formed by a support bracket base 4 and by two support bracket legs 5, 6 extending vertically downward from the edge of the base; the base 4 and the legs 5, 6 are embodied integrally with one another. In the region of the free end 7 of the support bracket 1, the legs 5, 6 have insertion wall portions 8 with an essentially triangular cross section. The insertion wall portions 8 are part of the legs 5 and 6, respectively, and are offset relative to them toward one another by approximately the thickness of the legs 5, 6. The wall portions 8 are defined relative to the respective legs 5 and 6 by stop edges 9, which define the insertion wall portion 8 relative to the legs 5 and 6. The opposed wall portions 8 each have one support bracket detent recess 10 of essentially rectangular cross section. The edge of the detent recess 10 oriented toward the free end 7 is designated the detent edge 11.

The metal lower bracket 2 likewise has a U-shaped cross section, open at the bottom, and is formed both by a lower bracket base 12 and by two lower bracket legs 13, 14, extending vertically downward from it; the base 12 and the legs 13, 14 are embodied in one piece. The support bracket 1 is dimensioned such that it can partly embrace the lower bracket 2. Two opposed receiving bores 15 are provided in the legs 13, 14.

The joint 3, embodied in one piece of plastic, has a U-shaped cross section with a joint base plate 16 and with two joint legs 17, 18, extending vertically downward at the edge of the base plate. Pockets that are closed at the bottom counter to the insertion direction 19 are disposed in front of both legs 17, 18 and are defined toward the outside by a pocket wall 21 as extending parallel to the respective legs 17 and 18. The pocket wall 21 has an essentially triangular cross section; the space enclosed by the pocket 20 is essentially equivalent to the insertion wall portion 8 in terms of its outer contour. On the inside of the pocket wall 21, a detent wedge 22 embodied as a support bracket detent body is provided; it rises in the direction opposite the insertion direction 19 and ends in a detent protrusion 23. The essentially rectangular cross section of the detent wedge essentially corresponds to the detent recess 10. On the inside of each of the legs 17 and 18, a respective cylindrical detent peg 24 is provided, whose diameter is slightly less than the diameter of the receiving bore 15. A longitudinal slot 25 is provided in the base plate 16 and merges with a transverse slot 26 on the end located counter to the insertion direction 19.

The assembly of the support bracket to a lower bracket 2 using the joint 3 will now be described. First, the lower bracket 2 is inserted into the joint 3 in the insertion direction 19, or optionally from below, until the detent pegs 24 snap into the receiving bores 15. It is possible to press the detent pegs 24 elastically apart, above all because of the presence of the longitudinal slot 25 and the transverse slot 26. Next, the unit comprising the lower bracket 2 and joint 3 is inserted in the insertion direction 19 into the free end 7 of the support bracket 1; the wall portions 8 are inserted into the pockets 20 until the detent wedge 22 snaps into the associated detent recess 10, and the detent edge 11 and detent protrusion 23 are in contact with one another. Since the pocket wall 21 is defined on only two sides, the detent wedge 22 can be pressed elastically outward upon the insertion of the support bracket 1. The outside 27 of the pocket wall 21 and the outside 28, located behind the stop edge 9 in the insertion direction 19, of the respective legs 5 and 6 are aligned with one another, thus lending them a seamless appearance. This is equally true for a stop 29, provided on the end located counter to the insertion direction 19, that is aligned with the top side 30 of the base 4. The lower bracket 2 is now elastically pivotably connected to the support bracket 1 and is pivotable about the detent pegs 24. The possible pivoting range between the lower bracket 2 and support bracket 1 is selected such that it is adapted to the variations in curvature in wiping a windshield or rear window of a motor vehicle. The advantage of the joint 3 is that assembling the lower bracket 2 and support bracket 1, which are both of metal, can be done simply, quickly and automatically, since all that has to be done is to lock the parts onto one another. An especially advantageous feature of the design of the joint 3 is that it results in an aesthetically uniform closure of the support bracket, and such functional elements as detent recesses or detent bodies are no longer visible.

A second embodiment of the invention will now be described, in conjunction with FIGS. 3-6. Identical parts are assigned the same reference numerals as in the first embodiment. Structurally different but functionally identical parts are given the same reference numerals with a prime. Otherwise, reference is made to the description of the first embodiment. In a distinction from the first embodiment, the detent recesses 10′ in the legs 5 and 6 take the form of a keyhole open at the bottom, as is shown in FIG. 5. In each of the pockets 20, a cylindrical peg 31 connected to the respective legs 17 and 18 is provided, which has a spring slit 32, making the peg 31 elastically compressible to a certain extent. For assembly, as in the first embodiment, the joint 3′ is locked onto the lower bracket 2. Next, the support bracket 1 is snapped from above onto the joint 3′, causing the pegs 31 to enter into engagement with the respective keyhole-shaped detent recesses 10′.

It is also possible, as shown in FIG. 6, to provide the detent recess 10′ in the form of a keyhole open toward the free end 7 of the support bracket 1. In that case, the connection of the joint 3′ to the support bracket is accomplished by inserting the joint into the support bracket 1 in the insertion direction 19. For the advantages upon assembly, see the description of the first embodiment.

1. A windshield wiper for motor vehicles, having
a) a support bracket (1) for connection to a wiper arm secured to a motor vehicle, wherein the support bracket (1) has
i) an essentially U-shaped cross section and
ii) at least one support bracket detent recess (10; 10′);
b) at least one lower bracket (2) for connection to a rubber wiper blade, wherein the lower bracket (2)
i) has an essentially U-shaped cross section,
ii) has at least one lower bracket detent recess (15), and
iii) is at least partly embraced by the support bracket (1); and
c) a joint (3; 3′) for pivotably connecting the at least one lower bracket (2) to the support bracket (1), wherein the joint (3; 3′) has
i) at least one lower bracket detent body (24) for locking onto the at least one lower bracket detent recess (15), and
ii) at least one support bracket detent body (22; 31) for locking onto the at least one support bracket detent recess (10; 10′), which support bracket detent body (22; 31) is provided in a pocket (20).

2. The windshield wiper of claim 1, characterized in that the joint (3; 3′) can be snapped, at least partly embracing the at least one lower bracket (2), onto the lower bracket (2).

3. The windshield wiper of claim 2, characterized in that the support bracket (1) has one free end (7), and that the joint (3; 3′) locked to the lower bracket (2) is insertable from the free end (7) into the support bracket (1) and can be locked onto this support bracket.

4. The windshield wiper of claim 3, characterized in that the free end (7) of the support bracket (1) can be partly received in the pocket (20).

5. The windshield wiper of one of the foregoing claims, characterized in that the joint (3; 3′) has two lower bracket detent bodies (24).

6. The windshield wiper of claim 5, characterized in that the joint (3; 3′) has a spring slit (25, 26) provided between the two lower bracket detent bodies (24).

7. The windshield wiper of one of the foregoing claims, characterized in that the at least one support bracket detent body (22) is embodied as wedge-shaped.

8. The windshield wiper of one of claims 1-6, characterized in that the at least one support bracket detent body (31) is embodied as peg-shaped.

9. The windshield wiper of claim 7, characterized in that the at least one support bracket detent recess (10) has an essentially rectangular cross section.

10. The windshield wiper of claim 8, characterized in that the support bracket detent recess (10′) has a keyhole shape open toward the outside.
